(19) United States
(12) Patent Application Publication
(10) Pub. No.: US 2017/0276073 A1
(43) Pub. Date: Sep. 28, 2017

(54) CONTROL DEVICE, ACTUATOR, MOTOR DEVICE, AND TURBOCHARGER

(71) Applicant: MITSUBISHI HEAVY INDUSTRIES, LTD., Tokyo (JP)

(72) Inventors: Yukio YAMASHITA, Tokyo (JP); Hiroyoshi KUBO, Tokyo (JP); Mitsufumi GOTO, Tokyo (JP); Musashi SAKAMOTO, Tokyo (JP)

(73) Assignee: MITSUBISHI HEAVY INDUSTRIES, LTD., Tokyo (JP)

(21) Appl. No.: 15/504,682

(22) PCT Filed: Feb. 6, 2015
(86) PCT No.: PCT/JP2015/053406

§ 371 Date: Feb. 17, 2017

(30) Foreign Application Priority Data
Oct. 29, 2014 (JP) 2014-219909

(51) Int. Cl. F02D 23/00

(52) U.S. Cl. CPC F02D 23/00

(57) ABSTRACT

A control device that controls a drive device for driving an auxiliary machine that assists the output of a main machine that is a power source, the control device including: a drive control unit for controlling the drive device; and an auxiliary machine control unit that controls all the drive devices provided in the auxiliary machine which includes the drive device, and thereby controls the auxiliary machine.

### TECHNICAL FIELD

The present invention relates to a control device, an actuator, a motor device, and a turbocharger.

Priority is claimed on Japanese Patent Application No. 2014-219909, filed on Oct. 29, 2014, the content of which is incorporated herein by reference.

### BACKGROUND ART

There are vehicles each equipped with an engine provided with a supercharger such as a turbocharger. A turbocharger generates compressed air by rotating a turbine by using exhaust gas discharged from an engine, and rotating a compressor connected coaxially with the turbine. The turbocharger increases the output efficiency of the engine by supplying the compressed air to the engine.

In the case of an engine provided with a turbocharger, there is a case where a control system is provided with an engine ECU (Electronic Control Unit) for mainly controlling the engine and a turbo ECU for controlling the turbocharger. In that case, it is common that the engine ECU and the turbo ECU are mounted on separate hardware.

As a related technique, Patent Document 1 discloses an ECU system composed of a main ECU and a sub ECU, which are provided with computers independent of each other.

### CITATION LIST

### Patent Literature

[Patent Document 1] Japanese Patent No. 4415912

### SUMMARY OF INVENTION

### Technical Problem

Disposing the turbo ECU at independent hardware, as described above, leads to occupation of a space and an increase in cost.

The present invention provides a control device, an actuator, a motor device, and a turbocharger, in which it is possible to solve the above-mentioned problem.

### Solution to Problem

According to a first aspect of the present invention, there is provided a control device that controls a drive device for driving an auxiliary machine that assists output of a main machine that is a power source, the control device including: a drive control unit for controlling the drive device; and an auxiliary machine control unit that controls all the drive devices provided in the auxiliary machine which includes the drive device, and thereby controls the auxiliary machine.

According to a second aspect of the present invention, in the control device, the drive device is an actuator.

According to a third aspect of the present invention, in the control device, the auxiliary machine is an electric turbocharger, and the drive device is a motor device.

According to a fourth aspect of the present invention, there is provided an actuator including: the control device according to the second aspect.

According to a fifth aspect of the present invention, there is provided a motor device including: the control device according to the third aspect.

According to a sixth aspect of the present invention, there is provided a turbocharger including: at least one of the actuator according to the fourth aspect and the motor device according to the fifth aspect.

### Advantageous Effects of Invention

According to the control device, the actuator, the motor device, and the turbocharger described above, it is possible to realize space saving and cost reduction of the turbo ECU by effectively utilizing a resource of the control device mounted on the actuator or the like provided in the turbocharger.

### BRIEF DESCRIPTION OF DRAWINGS

FIG. 1 is an example of a block diagram of a turbo engine system in an embodiment according to the present invention.

FIG. 2A is a first diagram showing a method of selecting a control device to be equipped with a turbo ECU, in the embodiment according to the present invention.

FIG. 2B is a second diagram showing the method of selecting a control device to be equipped with a turbo ECU, in the embodiment according to the present invention.

FIG. 2C is a third diagram showing the method of selecting a control device to be equipped with a turbo ECU, in the embodiment according to the present invention.

### DESCRIPTION OF EMBODIMENTS

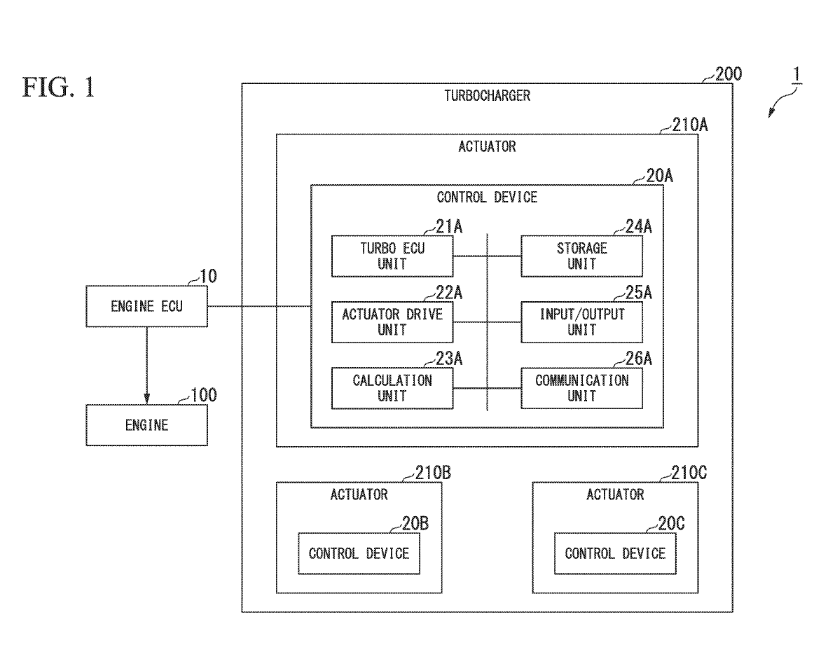

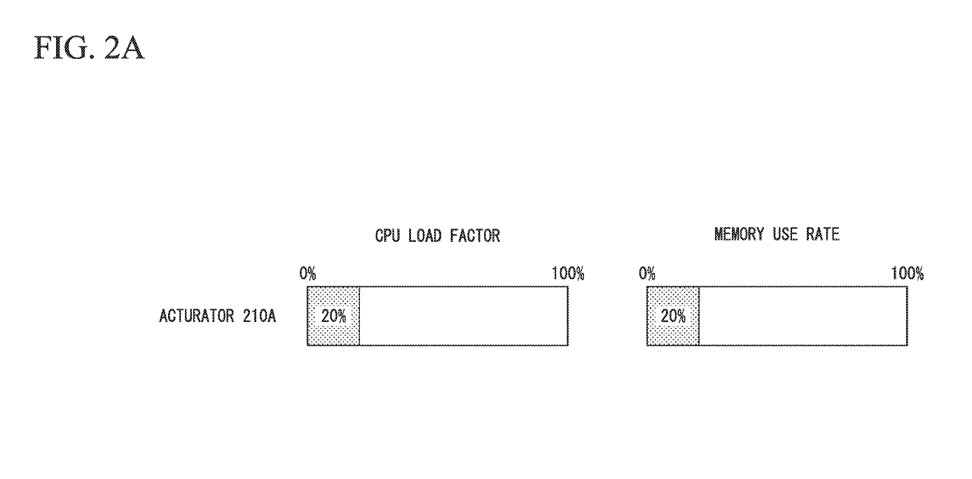

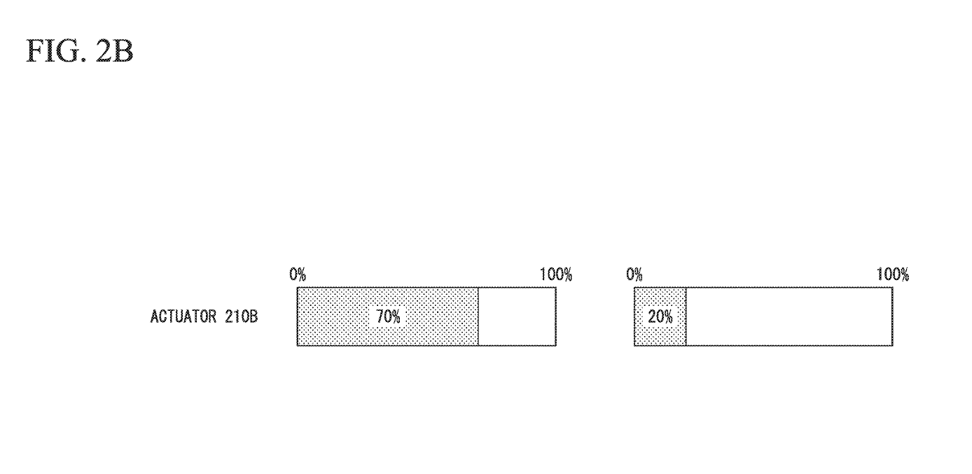

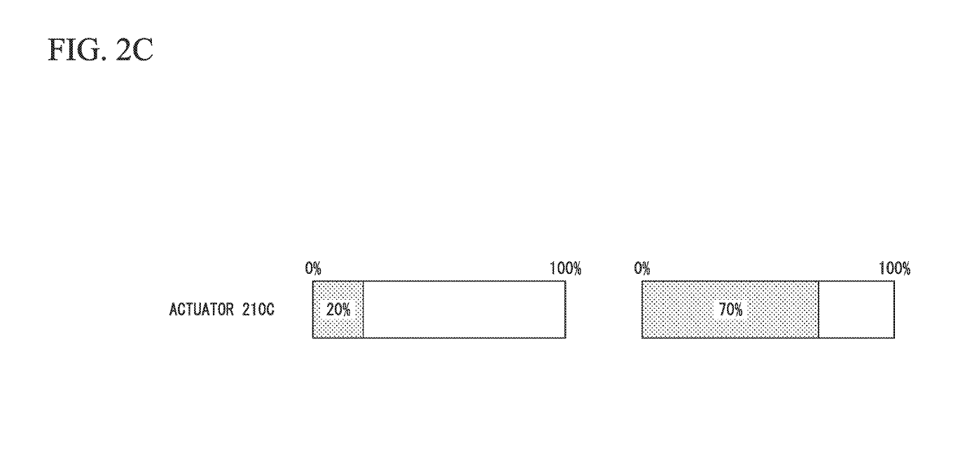

Hereinafter, a system according to an embodiment of the present invention will be described with reference to FIGS. 1, 2A, 2B, and 2C.

FIG. 1 is an example of a block diagram of a turbo engine system in an embodiment according to the present invention. A turbo engine system refers to an engine equipped with a turbocharger and a system that controls the engine. A turbo engine system 1 of this embodiment is configured to include an engine 100, an engine ECU 10, a turbocharger 200, actuators 210 (210A, 210B, and 210C), and control devices 20 (20A, 20B, and 20C).

The engine 100 is an internal combustion engine which extracts power by burning fuel in a cylinder.

The engine ECU 10 is composed of a microcomputer, a memory, various control circuits, and the like. The engine ECU 11 controls operations of the engine 100, such as fuel injection control and ignition control,

The turbocharger 200 is a type of supercharger. The turbocharger 200 supplies compressed air generated by rotating a turbine by using exhaust gas discharged from the engine 100, and rotating a compressor connected coaxially with the turbine, to the engine.

The actuators 210 (210A, 210B, and 210C) are drive devices each provided with a mechanism for driving the turbocharger 200, mounted on the turbocharger 200. The actuator 210 is, for example, an actuator of a variable turbine nozzle, or a motor device in an electric turbocharger. Alternatively, it is an actuator for controlling an operation of a bypass valve which controls the flow rate of the exhaust gas flowing into the turbine. The electric turbocharger is a turbocharger which is provided with a mechanism for rotating a turbine and a coaxial compressor by a motor device. If the electric turbocharger is used, it is possible to supplement the rotation of the turbine by the motor device even in a situation where the exhaust gas from the engine is insufficient at the time of start-up or the like, and therefore, it is possible to shorten a startup time of the turbocharger.

The control devices 20 (20A, 20B, and 20C) are controllers (arithmetic ICs) each composed of a microcomputer, a memory, an actuator drive circuit, and the like. The control device 20 controls an operation of the actuator 210. The control device 20 may be configured integrally with the actuator 210.

The engine ECU 10 leads control of the turbo engine system 1. However, with respect to an operation of the turbocharger 200, control thereof is left to a turbo ECU that is an ECU for the turbocharger. For example, the engine ECU 10 transmits a boost pressure command value to the turbo ECU, and the turbo ECU controls the boost pressure of the turbocharger 200, based on the command value. The engine ECU 10 controls the output of the engine by adjusting the boost pressure through the turbo ECU.

Here, considering a device equipped with the function of the turbo ECU, if a device equipped with a microcomputer or the like is provided exclusively for the turbo ECU, an increase in cost and occupation of a space are caused. Further, the engine 100 and the turbocharger 200 are often manufactured by different manufacturers. Generally, the engine ECU is made by the manufacturer of the engine and the turbo ECU is made by the manufacturer of the turbocharger 200. Therefore, it is expected that various restrictions are added to the mounting of the function of the turbo ECU on the same hardware as the engine ECU 10 and thus difficulty is involved in the mounting. In this embodiment, the turbo ECU is mounted on the control device 20 of the actuator 210 provided in the turbocharger 200. Then, it is possible to achieve cost reduction and space saving, compared to a case where hardware dedicated to the turbo ECU is introduced, and the manufacturer of the turbocharger can also relatively freely perform work of mounting the turbo ECU function.

Further, a control program of the turbo ECU is created in accordance with the standard specifications of automobile software such as AUTOSAR (Automotive Open System Architecture), and a control program of the actuator or the motor device provided in the turbocharger is also created in accordance with the standard specification of the same automobile software. Therefore, even in a case where the manufacturer of the turbocharger and the manufacturer of the actuator are different, mounting the control program of the turbo ECU on the control device 20 of the actuator or the motor device is easier than a case of transplanting the program to another platform.

Further, configuration of consistency between program modules on the same control device 20 at the stage of creating the control program (for example, between a program of a motor driver in a motor device and a control program of a turbo ECU which is newly added) is sufficiently possible by verification based on model-based development which is frequently introduced in the manufacturing industry such as the automobile industry.

Next, the control device 20 equipped with the function of the turbo ECU will be described. As shown in FIG. 1, the control device 20 is provided with a turbo ECU unit 21, an actuator drive unit 22, a calculation unit 23, a storage unit 24, an input/output unit 25, and a communication unit 26.

In FIG. 1, the control device 20 equipped with the function of the turbo ECU is the control device 20A, and other control devices 20B and 20C are not equipped with the function of the turbo ECU. Hereinafter, the configuration of the control device 20 will be described with reference to the control device 20A as an example.

A turbo ECU unit 21A is provided with the function of the turbo ECU. For example, the turbo ECU unit 21A generates a valve opening degree command signal for controlling a valve opening degree of a valve (hereinafter referred to as a “turbine valve”) that controls the flow rate of the exhaust gas flowing into the turbine so as to reach a boost pressure which is instructed by the engine ECU 10. In addition to this, the turbo ECU unit 21A also has a function of controlling various mechanisms of the turbocharger. However, a description thereof is omitted in this specification.

An actuator drive unit 22A generates a control signal for controlling an operation of the actuator 210A provided with the control device 20A. For example, in a case where the actuator 210A is an actuator for driving the above-described turbine valve, the actuator drive unit 22A generates a control signal for adjusting the valve opening degree of the turbine valve, based on the valve opening degree command generated by the turbo ECU unit 21.

A calculation unit 23A is a calculation device such as a DSP, a microcomputer, or a CPU.

A storage unit 24A is a memory such as a ROM or a RAM.

An input/output unit 25A performs input/output of data to and from another device of the actuator 210A provided with its own device (the control device 20). For example, the input/output unit 25A outputs the control signal generated by the actuator drive unit 22A to the actuator 210A.

A communication unit 26A performs communication with other devices. For example, the communication unit 26 receives a control signal from the engine ECU 10 to the turbo ECU unit 21A. Further, the communication unit 26 transmits the actuator control signal generated by the turbo ECU unit 21A to another actuator (for example, the actuator 210B).

The turbo ECU unit 21 and the actuator drive unit 22 are functions provided in the control device 20 by the calculation unit 23 reading and executing the program stored in the storage unit 24.

The configuration of each of the control device 20B and the control device 20C is the same as a configuration in which the sub ECU unit 21 is removed from the control device 20A.

Further, the control device 20 equipped with the turbo ECU unit 21 is preferably a control device that controls a so-called smart actuator in which a sensor is integrally incorporated, or a control device mounted on a motor device in an electric turbocharger. The smart actuator or the motor device requires more complicated control than a general actuator, and therefore, the smart actuator or the motor device is equipped with a control device having higher processing capacity than a control device incorporated into a general actuator. If there is a margin in the processing capacity of the control device, mounting of the turbo ECU unit 21 becomes possible.

The turbo ECU unit 21A controls the operation of the entire turbocharger 200. That is, the turbo ECU unit 21A generates control signals for the actuators 210A to 210C and outputs the control signals to the actuators 210A to 210C. With respect to the actuator 210A, the turbo ECU unit 21A outputs a control signal to the actuator drive unit 22A. With respect to the actuator 210B, the turbo ECU unit 21A outputs a control signal to the control device 20B through the communication unit 26A. In the control device 20B, an actuator drive unit 22B acquires a control signal through a communication unit 26B. The actuator 210C is also similar to the actuator 210B.

Even if the function of the turbo ECU is mounted on independent hardware, or even if the function of the turbo ECU is mounted on the control device 20A of the actuator, as in this embodiment, the function and configuration of the engine ECU 10 are not significantly affected. Further, also with respect to other actuators 210B and 210C, similarly, the functions and configurations of the actuators 210B and 210C are not significantly affected regardless of a location which is equipped with the function of the turbo ECU. With respect to the actuator 210A, regardless of a device which is equipped with the function of the turbo ECU, the processing of the actuator 210A is not significantly affected by only a difference of whether the control signal from the turbo ECU is acquired through the communication unit 26A or from the turbo ECU unit 21 through the memory (the storage unit 24A). Further, the cost necessary for mounting the turbo ECU unit 21 on the control device 20A is reduced compared to mounting the function of the turbo ECU on independent hardware. According to this embodiment, it is possible to realize space saving and cost reduction of the turbo ECU.

FIG. 2A is a first diagram showing a method of selecting the control device to be equipped with the turbo ECU, in the embodiment according to the present invention. FIG. 2B is a second diagram showing the method of selecting the control device to be equipped with the turbo ECU, in the embodiment according to the present invention. FIG. 2C is a third diagram showing the method of selecting the control device to be equipped with the turbo ECU, in the embodiment according to the present invention.

In this embodiment, in a case where there are a plurality of actuators each having the control device, the sub ECU unit 21 is mounted on the actuator determined to have the most margin by comparing a load factor of the calculation unit 23 or the used amount of the storage unit 24 between the actuators.

FIG. 2A shows the average values of a load factor (a CPU load factor) of the calculation unit 23 in a predetermined period (for example, a scene in which the actuator is operating) and a use rate of the storage unit 24 (a memory use rate) of the control device 20 that controls the actuator 210A. Similarly, FIG. 2B shows the average values of the CPU load factor and the memory use rate of the actuator 210B in a predetermined period, and FIG. 2C shows the average values of the CPU load factor and the memory use rate of the actuator 210C in a predetermined period.

The average CPU load factor of the actuator 210A is 20%, and the average memory use rate is 20%. The average CPU load factor of the actuator 210B is 70%, and the average memory use rate is 20%. The average CPU load factor of the actuator 210C is 20%, and the average memory use rate is 70%.

Here, a threshold value for determining whether or not there is a margin in each of the memory use rate and the CPU load factor is set to be 50%. In the actuator 210B, although there is a margin in the memory use rate (20%), there is no margin in the CPU load factor (70%). In the actuator 210C, although there is a margin in the CPU load factor (20%), there is no margin in the memory use rate (70%). In the actuator 210A, there are margins in both the CPU load factor (20%) and the memory use rate (20%). In such a case, if the turbo ECU units 21B and 21C are mounted on the control devices 20B and 20C of the actuators 210B and 210C, resources are insufficient. For this reason, a delay occurs in the processing of the turbo ECU unit 21, and thus there is a possibility that the control of the turbocharger will not be able to be performed accurately. On the other hand, if the turbo ECU unit 21A is mounted on the control device 20A of the actuator 210A, since there is a margin in the resource of the control device 20A, there is little possibility that a delay will occur in the processing of the turbo ECU unit 21A. Further, there is also an advantage that the resource of the control device 20A can be utilized effectively. Therefore, in this embodiment, the availability of the resources of the control devices 20 (20A to 20C) of the respective actuators is grasped by advance verification, and the turbo ECU 21 is mounted on the control device 20A having a margin.

In a case where there is a margin in the capacity of a nonvolatile memory (a ROM or a FLASH) in a storage unit 24B of the control device 20B, the turbo ECU unit 21 is mounted on the storage unit 24B, and in a case where there is a margin in a volatile memory (a RAM) of the storage unit 24 of the control device 20C, the turbo ECU unit 21 may be executed using a calculation unit 23C and a storage unit 24C (a RAM).

Further, in a case where there is no sufficient margin in any actuator, the hardware of any one of the control devices 20 may be enhanced and the turbo ECU 21 may be mounted on the control device 20. Generally, this hardware enhancement is less expensive and space-saving can also be realized, compared to a case where the hardware for the turbo ECU is provided independently.

According to this embodiment, new hardware for the turbo ECU 21 does not need to be provided, and therefore, it is possible to realize space saving and cost reduction of the turbo ECU 21.

In addition, it is possible to appropriately replace the constituent elements in the above-described embodiment with well-known constituent elements within a scope which does not depart from the gist of the present invention. Further, the technical scope of the present invention is not limited to the above-described embodiment, and it is possible to add various changes thereto within a scope which does not depart from the gist of the present invention. Further, the turbocharger is an example of an auxiliary machine that assists the output of a main machine that is a power source. The actuator drive unit 22 is an example of a drive control unit. The turbo ECU unit 21 is an example of an auxiliary machine control unit.

### INDUSTRIAL APPLICABILITY

According to the control device, the actuator, the motor device, and the turbocharger described above, it is possible to realize space saving and cost reduction of the turbo ECU by effectively utilizing the resource of the control device mounted on the actuator or the like provided in the turbocharger.

### REFERENCE SIGNS LIST

1: control system

10: engine ECU

20: control device

21: turbo ECU unit

22: actuator drive unit

23: calculation unit

24: storage unit

25: input/output unit

26: communication unit

100: engine

200: turbocharger

210: actuator

1-6. (canceled)

7. A control device incorporated in one drive device, among control devices which are respectively provided in a plurality of drive devices for driving an auxiliary machine that assists output of a main machine that is a power source, the control device comprising:
a drive control unit for controlling the one drive device; and
an auxiliary machine control unit that controls all of the plurality of drive devices including the one drive device, and thereby controls the auxiliary machine.

8. The control device according to claim 7, wherein the one drive device is an actuator.

9. The control device according to claim 7, wherein the auxiliary machine is an electric turbocharger, and
the one drive device is a motor device.

10. An actuator comprising:
the control device according to claim 8.

11. A motor device comprising:
the control device according to claim 9.

12. A turbocharger comprising:
at least one of the actuator according to claim 10 and a motor device.
